(19) United States
(12) Patent Application Publication
(10) Pub. No.: US 2017/0112702 A1
(43) Pub. Date: Apr. 27, 2017

(54) SPINAL COLUMN SUPPORT

(71) Applicants: Hee Soo KIM, Hanam-si, Gyeonggi-do (KR); T&I CO., LTD., Namyangju-si, Gyeonggi-do (KR)

(72) Inventor: Hee Soo KIM, Hanam-si, Gyeonggi-do (KR)

(73) Assignees: T&I CO., LTD., Namyangju-si, Gyeonggi-do (KR); Hee Soo KIM, Hanam-si, Gyeonggi-do (KR)

(21) Appl. No.: 15/317,107

(22) PCT Filed: Jun. 5, 2015
(86) PCT No.: PCT/KR2015/005649

§ 371 Date: Dec. 7, 2016

(30) Foreign Application Priority Data
Jun. 10, 2014 (KR) 10-2014-0070300
Jan. 27, 2015 (KR) 10-2015-0012648

(51) Int. Cl. A61H 1/00; A47C 7/46; A47C 31/00; A61H 39/04; A47C 7/42

(52) U.S. Cl. CPC A61H 1/008; A61H 39/04; A47C 7/425; A47C 31/00; A47C 7/46; A61H 2201/1623

(57) ABSTRACT

Disclosed is a spinal column support including a main body for supporting a user's spinal column, in which the main body includes: a sacrum accommodating groove which is concavely formed to accommodate the user's sacrum; and a lumbar vertebra support portion which supports a lumbar vertebra connected with the user's sacrum.

### TECHNICAL FIELD

The present invention relates to a spinal column support, and more particularly, to a spinal column support capable of allowing a user to get enough rest even in a state in which the user lies or is seated on a chair by applying a sacrum still point inducing technique and a lumbosacral traction release technique of a craniosacral therapy.

### BACKGROUND ART

A craniosacral therapy (CST) is a therapeutic method that has begun to be researched in U.S.A., and has a history of over 100 years. The craniosacral therapy may solve various problems caused by deterioration in circulation of a cerebrospinal fluid which are caused by membranous impairment of a central nerve system.

In the case of the normal circulation of the cerebrospinal fluid, the cerebrospinal fluid circulates in a flexion (inspiration, external rotation) pattern and in an extension (expiration, internal rotation) pattern in a cycle of 8 to 12 times per minute (the flexion and the extension cycle: once per 6 to 9 seconds), a cycle of circulation of the cerebrospinal fluid through the entire body is once per 6 to 7 hours, the cerebrospinal fluid circulates four to five times a day, and the amount of the created cerebrospinal fluid is 500 cc for a day.

The normal flow of the cerebrospinal fluid (CSF) relieves tension of membranes that surround the brain and the spinal cord which are included in a central nerve system, and relieves tension of fasciae connected to all external tissues, thereby improving circulation ability of all of capillaries and cells in the whole body, and operating a self-curative immune system.

The craniosacral therapy is a therapeutic method of adjusting a flow cycle of the cerebrospinal fluid to normal balance by precisely touching cranial bones and sacra with about 5 grams by hand and releasing restricted intracranial membranes and dura maters.

The balance of the cerebrospinal fluid has effects of reducing headache, muscle tension of a posterior region of a neck, neck stiffness, shoulder muscle pain, fever, acute and chronic musculoskeletal diseases, low back pain, degenerative arthritis, cerebral congestion, pulmonary congestion, and edema.

Therefore, it is necessary to easily utilize the craniosacral therapy even at home by inducing normal circulation of the cerebrospinal fluid by using a sacrum still point inducing technique with a single spinal column support, and by applying manipulative therapy, which relaxes the fasciae of the waist and the pelvis by using a lumbosacral traction release technique, to products.

In addition, it is necessary to provide a spinal column support which does not inconvenience the user even though the user uses a chair over a long period of time, and may be used when the user is seated on the chair so as to allow the user to get enough rest.

### DISCLOSURE

### Technical Problem

The problems to be solved by the present invention are as follows.

A first object is to enable a user to perform a craniosacral therapy by himself/herself when the user lies or is seated.

A second object is to allow the user to be subjected to the craniosacral therapy without limitations in respect to time and space.

A third object is to allow the user to maintain correct postures of the user's pelvis and lumbar vertebra.

A fourth object is to improve circulation ability of a human body and enhance an immune system by inducing circulation of a cerebrospinal fluid.

Technical problems of the present invention are not limited to the aforementioned technical problems, and other technical problems, which are not mentioned above, may be clearly understood by those skilled in the art from the following descriptions.

### Technical Solution

To solve the aforementioned problems, a spinal column support according to an exemplary embodiment of the present invention includes a main body for supporting a user's spinal column, in which the main body includes: a sacrum accommodating groove which is concavely formed to accommodate the user's sacrum; and a lumbar vertebra support portion which supports a lumbar vertebra connected with the user's sacrum.

In addition, a spinal column support according to another exemplary embodiment of the present invention includes a main body for supporting a user's spinal column, in which the main body includes: a sacrum accommodating groove which is concavely formed to accommodate the user's sacrum; a support protrusion which is formed at an end portion of the sacrum accommodating groove and interrupts the movement of the sacrum so as to interrupt the movement of a flexion phase of a sacrum caused by a flow of a cerebrospinal fluid; and a lumbar vertebra support portion which extends in a direction from the support protrusion to a user's spinal column and supports the user's spinal column.

In addition, a spinal column support according to still another exemplary embodiment of the present invention includes a main body for supporting a user's spinal column, in which the main body includes: a sacrum accommodating groove which defines a roughly elliptical groove; a support protrusion which protrudes at an edge of the sacrum accommodating groove; and a lumbar vertebra support portion which extends from the support protrusion and stimulates a user's waist muscle.

In addition, a spinal column support according to yet another exemplary embodiment of the present invention includes a main body for supporting a user's spinal column, in which the main body includes support protrusions which protrude at a position that faces a portion between an upper side of a sacra apex and a sacral base which corresponds to a triangular portion of the user's coccyx.

In addition, a spinal column support according to still yet another exemplary embodiment of the present invention includes a main body for supporting a user's spinal column, in which the main body includes: a lumbar vertebra support portion which stands up to face a backrest of a chair and supports the user's waist; and a gluteal region support portion which is placed on a seat of the chair and faces the user's gluteal muscle, and a stimulation crest protrudes on the lumbar vertebra support portion in a longitudinal direction in an elongated manner so as to stimulate a user's back muscle.

Other detailed matters of the exemplary embodiments are included in the detailed description and the drawings.

### Advantageous Effects

According to the present invention, there are effects as follows.

First, a user may perform a craniosacral therapy by himself/herself when the user lies or is seated.

Second, the user may be subjected to the craniosacral therapy without limitations in respect to time and space.

Third, postures of the user's pelvis and lumbar vertebra may be corrected to correct postures by stimulating back muscles.

Fourth, it is possible to improve circulation ability of a human body and enhance an immune system by inducing circulation of a cerebrospinal fluid.

The effects of the present invention are not limited to the aforementioned effects, and other effects, which are not mentioned above, will be clearly understood by those skilled in the art from the claims.

### Description of Drawings

FIG. 1 is a view briefly illustrating the circulation of a cerebrospinal fluid.

FIG. 2A is a view illustrating a flow of the cerebrospinal fluid and movements of cranial bones and a lumbar vertebra in a flexion phase, and FIG. 2B is a view illustrating a flow of the cerebrospinal fluid and movements of the cranial bones and the lumbar vertebra in an extension phase.

FIG. 3A is a view illustrating a release of an occipital region and a flow of the cerebrospinal fluid in the flexion phase, and FIG. 3B is a view illustrating a contraction of the occipital region and a flow of the cerebrospinal fluid in the extension phase.

FIG. 4 is a perspective view of a spinal column support according to one exemplary embodiment of the present invention.

FIG. 5 is a view schematically illustrating a sacrum.

FIG. 6 is a view schematically illustrating the sacrum and a long bone.

FIG. 7 is a top plan view illustrating the spinal column support according to one exemplary embodiment of the present invention.

FIG. 8 is a front view illustrating the spinal column support according to one exemplary embodiment of the present invention.

FIG. 9 is a view illustrating a spinal column and a sacrum, in which FIG. 9A is a side view, and FIG. 9B is a rear view.

FIG. 10 is a top plan view of a spinal column support according to another exemplary embodiment of the present invention.

FIG. 11 is a view illustrating a state in which the spinal column support according to one exemplary embodiment of the present invention is used.

FIG. 12 is a perspective view of a spinal column support according to still another exemplary embodiment of the present invention.

FIG. 13 is a top plan view of the spinal column support according to still another exemplary embodiment of the present invention.

FIG. 14 is a front view of the spinal column support according to still another exemplary embodiment of the present invention.

FIG. 15 is a rear view of the spinal column support according to still another exemplary embodiment of the present invention.

FIG. 16 is a side view of the spinal column support according to still another exemplary embodiment of the present invention.

FIG. 17 is a perspective view of the spinal column support according to yet another exemplary embodiment of the present invention.

FIG. 18A is a view illustrating spinal erector muscles, and FIG. 18B is a view illustrating quadratus lumborum muscles.

FIGS. 19A and 19B are views illustrating body points subjected to stimulation by the respective configurations illustrated in FIGS. 12 and 17.

FIG. 20 is a view illustrating a state in which the spinal column support according to yet another exemplary embodiment of the present invention is used.

### BEST MODE

Advantages and features of the present invention and methods of achieving the advantages and features will be clear with reference to exemplary embodiments described in detail below together with the accompanying drawings.

However, the present invention is not limited to the exemplary embodiments set forth below, and may be embodied in various other forms. The present exemplary embodiments are for rendering the disclosure of the present invention complete and are set forth to provide a complete understanding of the scope of the invention to a person with ordinary skill in the technical field to which the present invention pertains, and the present invention will only be defined by the scope of the claims. Throughout the specification, the same reference numerals denote the same constituent elements.

Hereinafter, the present invention will be described through exemplary embodiments of the present invention with reference to the drawings for explaining a spinal column support.

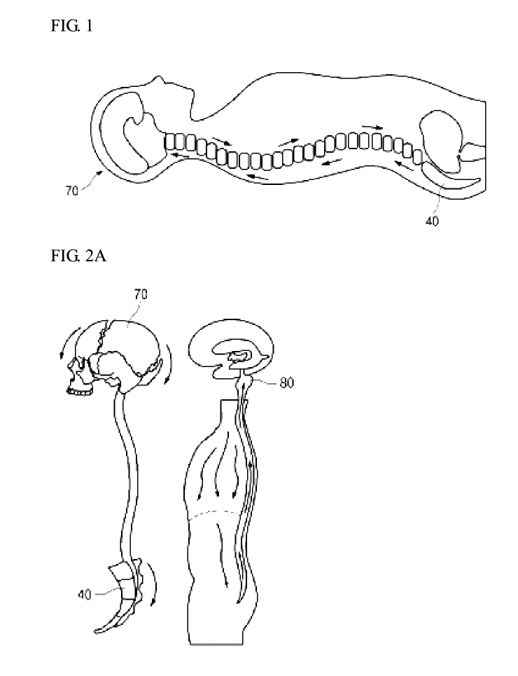

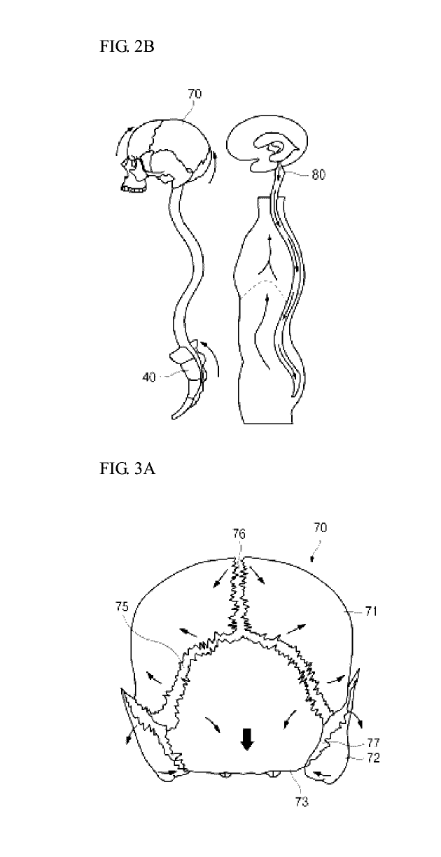

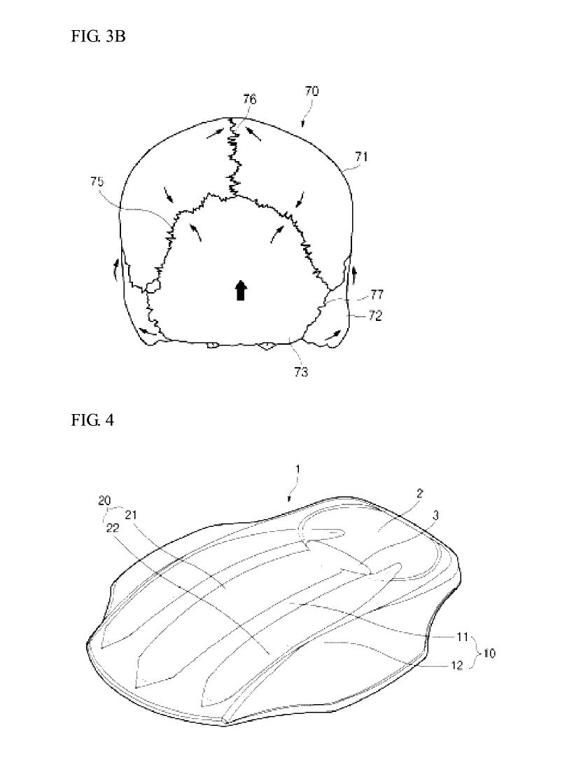

FIG. 1 is a view briefly illustrating the circulation of a cerebrospinal fluid. FIG. 2A is a view illustrating a flow of the cerebrospinal fluid and movements of cranial bones and a lumbar vertebra in a flexion phase, and FIG. 2B is a view illustrating a flow of the cerebrospinal fluid and movements of the cranial bones and the lumbar vertebra in an extension phase. FIG. 3A is a view illustrating a release of an occipital region and a flow of the cerebrospinal fluid in the flexion phase, and FIG. 3B is a view illustrating contraction of the occipital region and a flow of the cerebrospinal fluid in the extension phase.

Referring to FIGS. 1 to 3, it has been conventionally known that because cranial bones 70 of an adult are hardened and calcified, the cranial bones 70 coalesce in the hardened state, such that the cranial bones 70 cannot be moved. However, the cranial bones 70 are minutely moved to affect or be affected by a movement of a sacrum 40 (an upper side of a coccyx) and circulation of a cerebrospinal fluid of a human body. A craniosacral therapy is closely associated with the movement of the cranial bones 70.

Parietal bones 71 are quadrangular and flat bones that cover a rear upper side of a neurocranium in which a brain is placed. The number of the parietal bones 71 is two, and both the parietal bones 71 protrude outward. The two parietal bones 71 abut on each other through a sagittal suture 76. The parietal bones 71 are connected to an occipital bone 73 through a lambdoid suture 75. Temporal bones 72 are disposed in temporal regions. The cranial bones 70 are not hard structures, but tissues which have flexibility, and experience a flexion phase in which the cranial bones 70 are expanded when a cerebrospinal fluid is created, and an extension phase in which the cranial bones 70 are contracted when the creation of the cerebrospinal fluid is stopped.

With the aforementioned structures, the cranial bones 70 may be repeatedly contracted and released. A craniosacral rhythm shows information about stress or immunity. In the case of a healthy person, the flexion phase and the extension phase are cycled 8 to 12 times, such that the craniosacral movement of a healthy person is very stable.

The flexion means expansion or extension. The craniosacral rhythm can be sensed by hand. The feeling of the flexion transmitted to the hand can be understood as ‘a feeling that a body expands’ or ‘a feeling that the entire body rotates outward and becomes wide’, and the flexion is also called ‘an external rotation’.

The extension (compression) has an opposite concept or an opposite feeling to the flexion. The extension can be understood as contraction. The extension can be understood as ‘a feeling that a body is deeply drawn’. In some instances, the extension is explained as a feeling that the entire body rotates inward and becomes narrow. The extension is also called ‘an internal rotation’.

The cycle of the craniosacral movement includes two processes of the ‘flexion’ and the ‘extension’ or the ‘expansion’ and the ‘contraction’. A point between the flexion and the extension may be called ‘a neutral point’. At the neutral point, the human body feels that the human body is stopped, and the human body is in a ‘release’ state in which tension is relaxed. The cycles of the flexion and the extension may be constant and equal to each other. If the cycles of the flexion and the extension are different from or are not coincident with each other, the human body may have abnormality.

The flexion phase and the extension phase depend on the circulation of the cerebrospinal fluid (CSF). The cerebrospinal fluid is created in a cerebral ventricle. The cerebral ventricle refers to a space placed in a brain of the human body, and the cerebral ventricle is surrounded by an ependyma. The cerebral ventricles include lateral cerebral ventricles, a third cerebral ventricle, and a fourth cerebral ventricle 80. A total of four cerebral ventricles, which include two left and right cerebral ventricles, a single third cerebral ventricle, and a single fourth cerebral ventricle 80, constitute a cerebral ventricular system.

The lateral cerebral ventricles include two cerebral ventricles (a first cerebral ventricle and a second cerebral ventricle) disposed symmetrically at left and right sides in a space in a cerebrum, and the lateral cerebral ventricles are connected to each other through an interventricular foramen, and also connected with the third cerebral ventricle. The third cerebral ventricle is a space between the third cerebral ventricle and the diencephalon, and communicates with the lateral cerebral ventricle through the interventricular foramen, and the third cerebral ventricle is connected with the fourth cerebral ventricle 80 through a cerebral aqueduct. The fourth cerebral ventricle 80 communicates with the third cerebral ventricle through the cerebral aqueduct, and at this position, the fourth cerebral ventricle 80 also communicates with a subarachnoid space through a median aperture (Magendie's foramen) or a lateral aperture (Luschka's foramen).

The fourth cerebral ventricle 80 is surrounded by a cerebellum and a brainstem. The cerebrospinal fluid flows downward from the fourth cerebral ventricle 80 to a spinal cord through a myelocoele in the spinal cord or flows out of the brain through the median aperture or the lateral aperture and then circulates around the brain.

A structure called a choroid plexus is placed in the cerebral ventricle, and the choroid plexus serves to create the cerebrospinal fluid. The amount of the cerebrospinal fluid which is created by the choroid plexus for a day is about 500 ml, and consequently, the cerebral ventricle is always filled with the cerebrospinal fluid. A certain amount of the cerebrospinal fluid is created every day, and the amount of the cerebrospinal fluid identical to the certain amount disappears, and consequently, a constant amount of the cerebrospinal fluid is maintained in the cerebral ventricle. The cerebrospinal fluid circulates between the arachnoid and the dura mater, and serves to absorb shock. The cerebral ventricles contribute to creation, storage, and circulation of the cerebrospinal fluid, thereby ultimately serving to protect the brain.

First, the craniosacral therapy will be described.

The craniosacral system repeats the flexion process and the extension process. That is, the craniosacral system repeats the expansion and contraction processes. However, the movement of the craniosacral system may be completely stopped by an appropriate procedure.

This is called a still point. When the still point occurs, a patient may experience several changes. When the patient reaches the still point state, the patient may experience that a waist pain, which has occurred before, occurs again or various inactive pains, which has occurred before, recur. In addition, the patient's breathing is changed, or the patient may have a slightly sweating brow.

During the still point process, the human body begins to be relaxed. From this point, the pains, which have occurred before, disappear slowly. Further, sacroiliac somatic dysfunction at the waist and the pelvis begins to be corrected naturally. In some instances, joints are corrected with a snap. Subsequently, the patient breathing also becomes stable, and tensed muscles begin to be relaxed. The still point is maintained from as short as several seconds to as long as several minutes. When the still point phenomenon ends, the movement of the craniosacral system begins again. From the general observation, amplitude of a symmetrical and increased movement is detected.

The still point occurs most frequently at the head and the sacrum. When various techniques are applied to the head and the sacrum, the still point effect typically occurs more slightly quickly at the head and the sacrum than at other portions. The still point is effective in smoothly adjusting an action of the craniosacral system.

Hereinafter, a spinal column support according to one exemplary embodiment of the present invention, which adopts the craniosacral therapy, will be described.

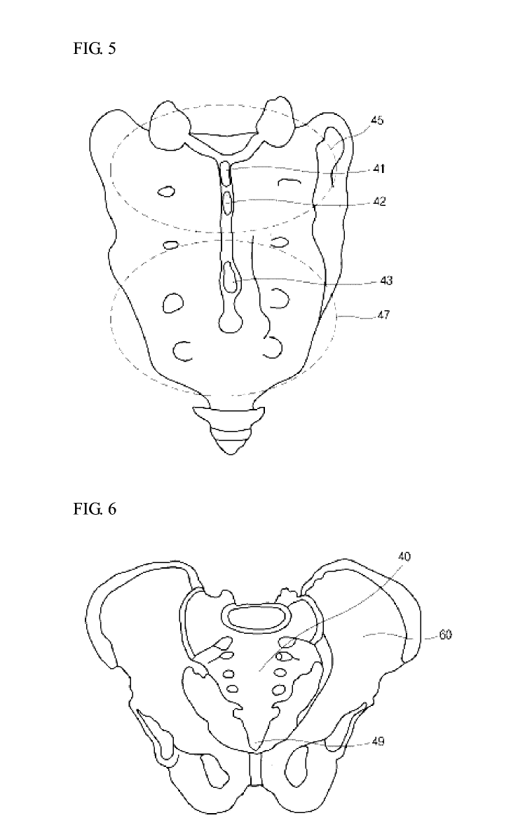

FIG. 4 is a perspective view of a spinal column support according to one exemplary embodiment of the present invention. FIG. 5 is a view schematically illustrating a sacrum. FIG. 6 is a view schematically illustrating the sacrum and a long bone.

Referring to FIGS. 4 to 6, the spinal column support according to one exemplary embodiment of the present invention includes a main body for supporting a user's spinal column, in which the main body 1 includes: a sacrum accommodating groove 2 which is concavely formed to accommodate the user's sacrum 40; and a support protrusion 3 which protrudes to support a part of the user' sacrum 40 when the user's sacrum 40 is positioned in the sacrum accommodating groove 2.

The spinal column includes a cervical vertebra, a thoracic vertebra, a lumbar vertebra, a sacral vertebra, and a coccygeal vertebra. The main body 1 is disposed on a floor on which the user lies, and supports the spinal column. The user lies on the main body 1. The main body 1 is disposed to face the user's back. The sacrum 40 is a bone that constituents the pelvis, is configured with five coupled sacral vertebrae, and has the largest size among the spinal vertebrae that constitute the vertebral column. The sacrum 40 has approximately an inverted triangular shape. The sacrum accommodating groove 2 is formed concavely to accommodate the sacrum 40.

The support protrusion 3 supports a part of the sacrum 40. Since the user lies on the main body 1, the user pushes the support protrusion 3 with the body weight. The support protrusion 3 exerts pressure on the user's sacrum 40 with reaction force to the user's body weight.

The support protrusion 3 is positioned at a position that corresponds to the user's sacrum 40. The position of the support protrusion 3 may vary for each country, race, and age based on an average skeleton of the human body. The size and the position of the support protrusion 3 may vary depending on a level of user group based on the sacrum accommodating groove 2. For example, the main body 1, which aims at users having a large body, may be positioned at a position higher than the position of the support protrusion 3 which aims at users having a small body.

The support protrusion 3 may be formed at a position that corresponds to at least any one of a first sacrum 41 and a second sacrum 42 of the user. The first sacrum 41 is also called a first sacral vertebra, and the second sacrum 42 is also called a second sacral vertebra. The first sacrum 41 is a bone protruding at a lower side of a fifth lumbar vertebra 55. The second sacrum 42 is a bone protruding at a lower side of the first sacrum 41. The support protrusion 3 may exert pressure on at least any one of the first sacrum 41 and the second sacrum 42. In the flexion phase, the first sacrum 41 and the second sacrum 42 rotate toward the floor on which the user lies. However, the support protrusion 3 supports the first sacrum 41 and the second sacrum 42, thereby interrupting the flexion phase. Therefore, the support protrusion 3 induces the user's still point.

The support protrusion 3 is formed at a position that corresponds to a user's sacrum upper part 45, and the sacrum accommodating groove 2 accommodates a user's sacrum lower part 47. The first, second, third, and fourth sacra 40 may be present sequentially in a direction from the fifth lumbar vertebra 55 to a coccygeal vertebra (coccyx) 49. The first sacrum 41 and the second sacrum 42 may be called the sacrum upper part 45, and a lower side of a third sacrum 43 may be called the sacrum lower part 47. The support protrusion 3 exerts reaction force to the sacrum upper part 45, thereby interrupting the flexion phase. The sacrum lower part 47 is accommodated in the sacrum accommodating groove 2. The support protrusion 3 may be formed at an upper end of the sacrum accommodating groove 2.

The support protrusion 3 may be formed to be spaced apart from the user's fifth lumbar vertebra 55 so as not to support a load of the user's fifth lumbar vertebra 55. The support protrusion 3 exerts reaction force to at least any one of the first sacrum 41 and the second sacrum 42. However, since the support protrusion 3 is formed to be spaced apart from the fifth lumbar vertebra 55, the fifth lumbar vertebra 55 cannot be supported by the support protrusion 3 such that the fifth lumbar vertebra 55 is tilted downward. Therefore, the fifth lumbar vertebra 55 and the sacrum 40 may be moved in a direction away from each other. Muscles, which connect the fifth lumbar vertebra 55 and the sacrum 40, are relaxed. Therefore, the user may eliminate compression of the sacrum 40 caused by gravity, and relieve tension of the muscles.

The support protrusion 3 is formed between the user's long bones 60, and may be formed within a size range in which the support protrusion 3 does not support the user's long bone 60. The long bones 60 are bones formed at left and right sides of the sacrum 40, and refer to flat bones having a fan shape while occupying an upper side of innominate bones. If the size of the support protrusion 3 is too large, pressure exerted on the long bone or the posterior superior iliac spine (PSIS) may be dispersed 10 instead of the sacrum 40. Therefore, the size of the support protrusion 3 may be smaller than the size of the sacrum 40. In addition, the support protrusion 3 may have a shorter transverse length than the sacrum 40, and thus may be formed between the long bones 60 at outer lateral sides of the sacrum.

The main body 1 according to one exemplary embodiment of the present invention includes a lumbar vertebra support portion 5 for supporting the user's lumbar vertebra 50. The lumbar vertebra 50 means a lumbar spine, and is the largest bone among the spinal vertebrae that constitute the vertebral column in the in the human body anatomy. The features of the lumbar vertebra 50, which are distinguished from the features of the other spinal vertebrae, are that no transverse foramen is formed in the transverse process and no articular surface is formed at a lateral side of a body of the vertebra. The number of lumbar vertebrae is five, and from the upper side, the uppermost bone is named a first lumbar vertebra, and the lowermost bone is named a fifth lumbar vertebra. The lumbar vertebra plays the most important role in respect to the movement of the human body, and serves to bear the most of the body weight. The number of the lumbar vertebrae 50 is five, and the lumbar vertebrae 50 may be divided into the first, second, third, fourth, and fifth lumbar vertebrae 50 from the upper side. The sacrum 40 is connected with a lower end portion of the fifth lumbar vertebra 55. The main body 1 includes the lumbar vertebra support portion 5. The lumbar vertebra support portion 5 supports the user's lumbar vertebra 50. The lumbar vertebra support portion 5 exerts reaction force, which is caused by the user's body weight, on the user.

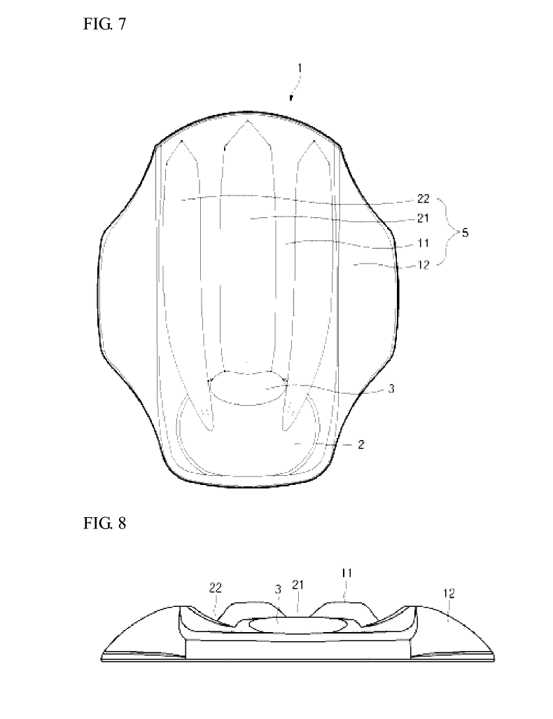

FIG. 7 is a top plan view illustrating the spinal column support according to one exemplary embodiment of the present invention. FIG. 8 is a front view illustrating the spinal column support according to one exemplary embodiment of the present invention. FIG. 9 is a view illustrating a spinal column and a sacrum, in which FIG. 9A is a side view, and FIG. 9B is a rear view.

Referring to FIGS. 7 to 9, the lumbar vertebra support portion 5 may include at least one trough 20 and at least two crests 10. The lumbar vertebra support portion 5 includes the crest 10 and the trough 20. The crest 10 protrudes to exert reaction force on the user. The trough 20 is formed between the crests 10.

The crest 10 includes an inner stimulation crest 11 which protrudes in an elongated manner to support the user's spinal erector muscle. The spinal erector muscles are muscles that extend in an elongated manner along lateral sides of the spinal column. The inner stimulation crest 11 supports the spinal erector muscle, and exerts reaction force on the spinal erector muscle. The inner stimulation crest 11 relaxes the spinal erector muscle.

The plurality of inner stimulation crests 11 is formed, and the trough 20 includes an inner trough 21 which is formed between the inner stimulation crests 11 and accommodates a spinous process 51 of the user's lumbar vertebra. Since the spinal erector muscles are vertically formed at the left and right sides of the spinal column, the inner stimulation crests 11 may be formed in an elongated manner at left and right sides based on the spinal column, respectively.

The lumbar vertebral spinous process 51 is also called a spinous process, and is a structure which protrudes immediately rearward from a point where the laminae meet at both sides, and the lumbar vertebral spinous process 51 is tilted slightly downward. Several muscles and several ligaments are attached to the lumbar vertebral spinous process 51. The inner trough 21 is vertically formed in an elongated manner so that the lumbar vertebral spinous process 51 may be inserted into the inner trough 21. The inner stimulation crests 11 protrude at the left and right sides of the inner trough 21.

The inner trough 21 extends toward the center of the support protrusion 3 and may meet the support protrusion 3. The inner trough 21 is formed to be directed toward the support protrusion 3. The inner trough 21 is formed on a centerline of the human body because the inner trough 21 accommodates the lumbar vertebral spinous process 51. In addition, the support protrusion 3 is formed on the centerline of the human body because the support protrusion 3 supports the sacrum 40. Therefore, the inner trough 21 and the sacrum 40 may be formed on the same line.

The inner stimulation crest 11 may extend from the support protrusion 3, and may be formed in parallel with the user's spinal column. The inner stimulation crests 11 are formed at the positions that face the spinal erector muscles present at the left and right sides of the lumbar vertebra 50, and thus the inner stimulation crests 11 extend vertically from the support protrusion 3.

The crest 10 includes an outer stimulation crest 12 which protrudes in an elongated manner to support the user's quadratus lumborum muscle. The quadratus lumborum muscle of the lumbar vertebra 50 is present between a twelfth rib and an iliac crest 60 outside the lumbar vertebra 50. The quadratus lumborum muscle is dictated by branches of subcostal nerve and lumbar plexus, and performs a rear extension of a trunk. The outer stimulation crest 12 exerts reaction force to the quadratus lumborum muscle.

The plurality of outer stimulation crests 12 is formed, and the inner stimulation crest 11 may be formed between the outer stimulation crests 12. Since the quadratus lumborum muscle is formed to be horizontally symmetrical based on the lumbar vertebra 50, the plurality of outer stimulation crests 12 may be formed. The quadratus lumborum muscle is formed further outward than the spinal erector muscle based on the spinal column. Therefore, the inner stimulation crest 11 is formed to be more adjacent to the spinal column than the outer stimulation crests 12.

The trough 20 includes outer troughs 22 which are formed between the inner stimulation crest 11 and the outer stimulation crests 12 so that pressure is concentrated on the user's spinal erector muscle. An area of the outer stimulation crest 12 needs to be restricted so that the outer stimulation crest 12 exerts appropriate reaction force on the quadratus lumborum muscle. Therefore, a groove is formed between the inner stimulation crest 11 and the outer stimulation crest 12. The outer trough 22 defines a space, which does not come into contact with the human body, between the outer stimulation crest 12 and the inner stimulation crest 11.

The outer trough 22 may extend into the sacrum accommodating groove 2, and the support protrusion 3 may be formed between the outer troughs 22. The outer trough 22 extends into the sacrum accommodating groove 2. The outer trough 22 also serves to restrict the size of the support protrusion 3. Therefore, the outer trough 22 may concentrate reaction force of the support protrusion 3 on the sacrum 40.

The outer stimulation crests 12 extend in a direction toward the sacrum accommodating groove 2, and may form an edge of the sacrum accommodating groove 2. The outer stimulation crests 12 extend in a direction toward the sacrum accommodating groove 2, and may form left and right sides of the sacrum accommodating groove 2 and a lower edge of the sacrum accommodating groove 2. The outer stimulation crest 12 protrudes while forming a projection at the edge of the sacrum accommodating groove 2.

The spinal column support according to one exemplary embodiment of the present invention includes the main body for supporting the user's spinal column, and the main body includes: the sacrum accommodating groove 2 which is concavely formed to accommodate the user's sacrum 40; the support protrusion 3 which is formed at an end portion of the sacrum accommodating groove 2 and interrupts the movement of the sacrum 40 so as to interrupt the flexion phase of the sacrum 40 which is caused by a flow of the created cerebrospinal fluid; and the lumbar vertebra support portion 5 which extends from the support protrusion 3 in a direction toward the user's spinal column and supports the user's lumbar vertebra 50.

The sacrum accommodating groove 2 accommodates the user's sacrum 40 and assists the user in lying at an exact position. In the flexion phase, the sacrum 40 may rotate, and the support protrusion 3 interrupts the movement of the sacrum 40. Therefore, the human body may be induced to the still point. The lumbar vertebra support portion 5 assists the user in lying comfortably and maintaining the user's posture. The lumbar vertebra support portion 5 pushes the spinal erector muscle and the quadratus lumborum muscle, thereby generating an acupressure effect. In addition, the inner trough 21 allows the lumbar vertebra spinous process 51 to be inserted into the inner trough 21, thereby assisting the user in maintaining the user's straight posture.

The spinal column support according to one exemplary embodiment of the present invention includes the main body for supporting the user's spinal column, and the main body includes: the sacrum accommodating groove 2 which defines approximately an elliptical groove; the support protrusion 3 which protrudes at the edge of the sacrum accommodating groove 2; and the lumbar vertebra support portion 5 which extends from the support protrusion 3 and has at least one crest 10 and at least one trough 20.

The sacrum accommodating groove 2 may have a circular or elliptical shape. The lumbar vertebra support portion 5 is formed at an upper side of the sacrum accommodating groove 2, and maintains the user's straight posture. The support protrusion 3 is formed at the edge of the sacrum accommodating groove 2, and a starting point of the support protrusion 3 may be positioned in the sacrum accommodating groove 2. Therefore, the support protrusion 3 may be formed at both inner and outer sides of the sacrum accommodating groove 2.

The crest 10 includes the plurality of inner stimulation crests 11 which extend from the support protrusion 3 in a direction away from the sacrum accommodating groove 2, and the trough 20 includes the inner trough 21 formed between the plurality of inner stimulation crests.

The crest 10 and the trough 20 are formed in the lumbar vertebra support portion 5, exert pressure on the muscles, and relax the muscles. The crest 10 and the trough are formed from the support protrusion 3 in a direction of the spinal column. The crest 10 and the trough may be formed symmetrically at both sides based on the spinal column. The inner trough 21 defines a space which is formed between the inner stimulation crests 11 and accommodates the lumbar vertebra 50.

The crest 10 includes the outer stimulation crest 12 which protrudes to define the edge of the sacrum accommodating groove 2 and extends in a direction roughly parallel to a direction of the inner stimulation crest 11, and the trough 20 includes the outer trough 22 formed between the outer stimulation crest 12 and the inner stimulation crest 11. The crest 10 includes the outer stimulation crest 12, and the outer stimulation crest 12 is formed in parallel with the inner stimulation crest 11. The outer trough 22 defines a space formed between the outer stimulation crest 12 and the inner stimulation crest 11, restricts the sizes of the outer stimulation crest 12 and the inner stimulation crest 11, and is formed vertically in an elongated manner to exert pressure on the muscles and fasciae.

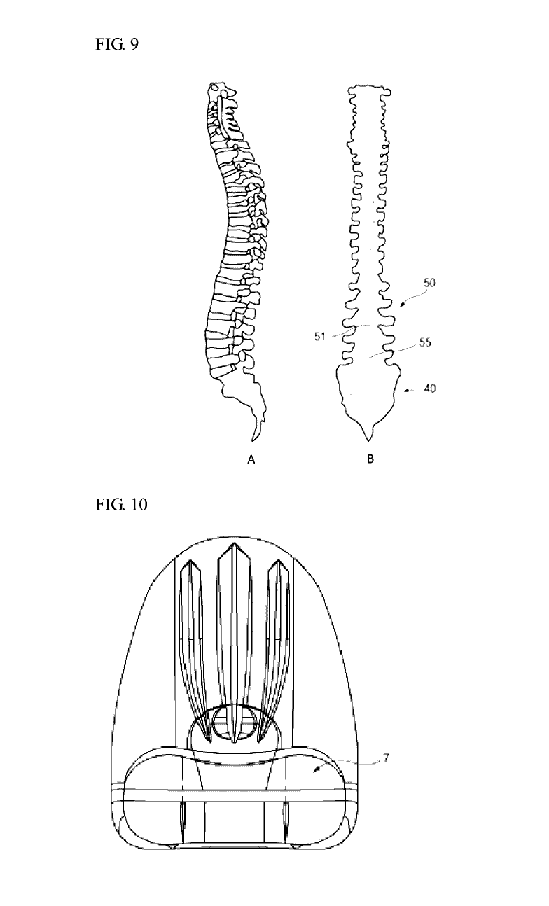

FIG. 10 is a top plan view of a spinal column support according to another exemplary embodiment of the present invention. The spinal column support according to one exemplary embodiment of the present invention may include a gluteal region support portion 7 formed to face the user's gluteal muscle. The gluteal region support portion 7 accommodates a gluteal region. Because the gluteal region protrudes, the gluteal region support portion 7 fixes the gluteal region. Therefore, the gluteal region support portion 7 serves to fix the main body 1 even though the user slightly moves.

FIG. 11 is a view illustrating a state in which the spinal column support according to one exemplary embodiment of the present invention is used. As illustrated in the drawing, the user may lie on the spinal column support according to one exemplary embodiment of the present invention, and may use the spinal column support as a waist pillow. The gluteal region support portion 7 fixes the position of the main body 1. Further, the lumbar vertebra support portion 5 performs acupressure on the back muscles by stimulating the user's back muscles. In addition, the sacrum accommodating groove 2 and the support protrusion 3 induce the still point, thereby assisting the circulation of the cerebrospinal fluid.

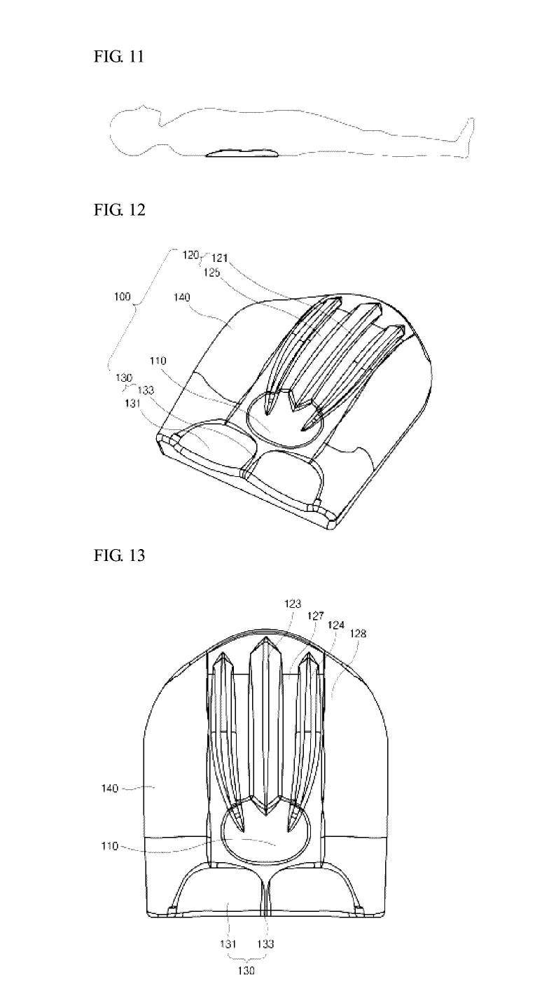

FIG. 12 is a perspective view of a spinal column support according to still another exemplary embodiment of the present invention.

Referring to FIG. 12, the spinal column support according to still another exemplary embodiment of the present invention includes a main body 100 for supporting the user's spinal column, and the main body 100 includes a sacrum accommodating groove 110 which is recessed to surround and support the user's sacrum.

The sacrum is a bone that constituents the pelvis, is configured with five coupled sacral vertebrae, and has the largest size among the spinal vertebrae that constitute the vertebral column. The sacrum is formed approximately in an inverted triangular shape. At least a part of the sacrum is accommodated in the sacrum support portion.

With the recessed shape, the sacrum accommodating groove 110 surrounds the sacrum and smoothly supports the sacrum. When the sacrum accommodating groove 110 smoothly supports the sacrum, the balance of the flexion phase and the extension phase of the cerebrospinal fluid is adjusted. In addition, the adjustment of the balance increases a flow of the cerebrospinal fluid.

FIG. 13 is a top plan view of the spinal column support according to still another exemplary embodiment of the present invention.

Referring to FIG. 13, the sacrum accommodating groove 110 is formed at a position where the user's medial sacral crest is accommodated.

The sacrum is configured with the five coupled sacral vertebrae. The five sacral vertebrae are connected to form the medial sacral crest. The sacrum accommodating groove 110 is formed at a position where the sacral crest is accommodated. The sacrum accommodating groove 110 is formed at a position where the first sacral vertebra, the second sacral vertebra, the third sacral vertebra, the fourth sacral vertebra, and the fifth sacral vertebra are accommodated. However, because the specific position and the size of the sacrum accommodating groove 110 may vary for each race and age, the specific position and the size of the sacrum accommodating groove 110 may be appropriately changed.

The main body 100 has a lumbar vertebra support portion which stands up to face a backrest of a chair and supports the user's waist, and a gluteal region support portion 130 which is placed on a seat of the chair and faces the user's gluteal muscle, and the sacrum accommodating groove 110 is formed between the gluteal region support portion 130 and the lumbar vertebra support portion 120.

The lumbar vertebra 50 is a bone structure that supports a backbone at an upper side thereof and is connected with the sacrum at a lower side thereof, and the lumbar vertebra 50 is present between the backbone and the sacrum. The lumbar vertebra 50 supports the human body and maintains equilibrium by means of ligaments and muscles from the backbone to the pelvis. In addition, the lumbar vertebra 50 serves to protect the spinal cord and enables the movement of the spinal column. The lumbar vertebra support portion 120 has an approximately board shape.

The gluteal region is a region having protruding flesh from a lower side of the waist to upper left and right sides of the thigh, and the gluteal region is also called a buttock. The gluteal muscles serve to stand and spread the pelvis straight for each step, and do not have a great effect on the user on an ordinary life, but play an important role when the user does strenuous exercise such as running. The buttocks typically have a high proportion of fat, and include three types of muscles including a gluteus maximus, a gluteus medius, and a gluteus minimus.

The gluteal region support portion 130 has gluteal region accommodating grooves 131 which are recessed to accommodate the user's protruding gluteal muscle, the gluteal region accommodating grooves 131 are divided into left and right grooves by a separation crest 133 which protrudes at a portion that faces the user's coccygeal vertebra. The sacrum accommodating groove 110 is formed on an extending line in a direction from the separation crest 133 to the lumbar vertebra support portion 120.

The coccygeal vertebra is a last part of the spinal vertebrae which is connected at a lower side of the sacrum, and includes four to five small spinal column segments in many cases. The coccygeal vertebra is an end of the spinal column, and is positioned at a last part of the pelvis between the both buttocks.

The shapes of the separation crest 133 and the gluteal region accommodating grooves 131 correspond to the structure of the human body. Therefore, the separation crest 133 and the gluteal region accommodating grooves 131 are in close contact with the user, and the sacrum accommodating groove 110 accommodates and supports the sacrum. The separation crest 133 is formed in a longitudinal direction in an elongated manner, and the sacrum accommodating groove 110 is formed at the end of the separation crest.

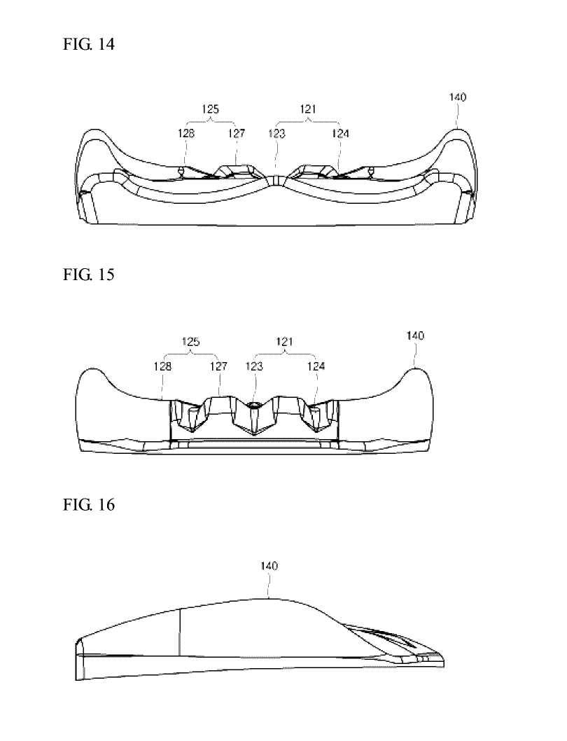

FIG. 14 is a front view of the spinal column support according to still another exemplary embodiment of the present invention. FIG. 15 is a rear view of the spinal column support according to still another exemplary embodiment of the present invention.

Referring to FIGS. 14 and 15, the lumbar vertebra support portion 120 has an inner trough 123 which is recessed to accommodate the user's lumbar vertebral spinous process (lumbar spinosis) 51.

The inner trough 123 extends in the longitudinal direction, and one side of the inner trough 123 is connected to the sacrum accommodating groove 110. The lumbar vertebral spinous process 51 is also called a lumbar spinous process, and is a structure which protrudes immediately rearward from a point where the laminae meet at both sides, and the lumbar vertebral spinous process 51 is tilted slightly downward. Several muscles and several ligaments are attached to the lumbar vertebral spinous process 51. The inner trough 123 has a shape that accommodates the lumbar vertebral spinous process 51. That is, because pressure is not concentrated only on a part of the protruding lumbar vertebral spinous process 51, the user feels comfortable. The lumbar vertebra support portion 120 has inner stimulation crests 127 which protrude at the left and right sides of the inner trough 123 and stimulate the user's spinal transverse process and erector muscles.

The spinal erector muscles 95 refer to muscles that extend vertically in an elongated manner along the spinal column. As can be seen from the name ‘erector muscle’, the erector muscle serves to allow the spinal column to stand upright straight. Therefore, the spinal erector muscles 95 are very important muscles to the human who walks erect. The spinal erector muscles 95 support trapezius muscles and latissimus muscles from an inner side, thereby enabling the shape of the body to be maintained correctly.

The inner stimulation crest 127 relaxes the transverse process 53 of the lumbar vertebra and the spinal erector muscle 95, thereby relieving fatigue of the spinal erector muscle 95. The gluteal region support portion 130 and the lumbar vertebra support portion 120 enable the user's pelvis and spinal erector muscle 95 to be maintained in correct postures.

Based on the inner stimulation crest 127, the lumbar vertebra support portion 120 has the inner trough 123 formed at one side, and outer troughs 124 formed at the opposite sides in an elongated manner.

With the inner trough 123 and the outer troughs 124, a degree of stimulation of the inner stimulation crest 127 is increased. The inner stimulation crests 127 and outer stimulation crests 128 are formed in the longitudinal direction in an elongated manner.

Based on the outer troughs 124, the inner stimulation crests 127 are formed at one side, and the outer stimulation crests 128, which stimulate the user's quadratus lumborum muscle 97, are formed at the opposite sides.

The quadratus lumborum muscle 97 is attached to the last rib, and the transverse processes of the first to fourth lumbar vertebrae 50, and thus attached to the iliac crest. Both portions of the quadratus lumborum muscle 97 are contracted together, such that the quadratus lumborum muscle 97 serves as an extensor that tilts or spreads the waist rearward.

The quadratus lumborum muscles 97 are thick and large muscles that contribute to vertical stabilization of the spinal column, and in the case of a patient who suffers from scoliosis or a symptom of the scoliosis, when one side of the quadratus lumborum muscle 97 is shortened, the other side of the quadratus lumborum muscle 97 may become tightened or loosened.

The quadratus lumborum muscle 97 plays an important role of holding the pelvis together with the gluteus medius when the user walks. The quadratus lumborum muscle 97 may cause waist pain, and cause distortion of the pelvis.

The outer stimulation crest 128 stimulates the quadratus lumborum muscle 97, and relaxes the quadratus lumborum muscle 97. Therefore, it is possible to relieve fatigue of the quadratus lumborum muscle 97, and correct the pelvis. In addition, low back pain is also relieved.

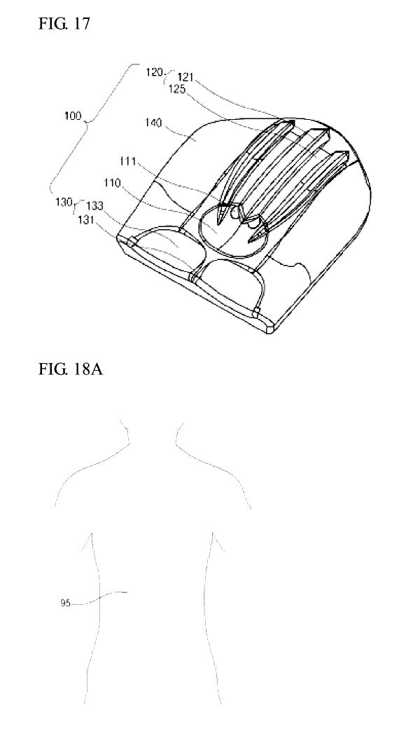

FIG. 16 is a side view of the spinal column support according to still another exemplary embodiment of the present invention.

Referring to FIG. 16, lateral support portions 140 vertically protrude in an elongated manner at left and right ends of the lumbar vertebra support portion 120, and fix the user's waist.

The lateral support portions 140 are formed at the left and right sides of the lumbar vertebra support portion 120, respectively. The lateral support portion 140 prevents the user's lumbar vertebra 50 from being tilting in one direction. Therefore, the lateral support portion 140 induces a correct posture of the lumbar vertebra 50. In addition, in the case of a seat in a vehicle, the lateral support portion 140 prevents the lumbar vertebra 50 from being tilted when the vehicle travels around a corner, thereby inducing a correct posture while the user drives the vehicle.

The lateral support portion 140 extends up to a portion that does not come into contact with the user's rib, and the inner stimulation crest 127 and the outer stimulation crest are formed to be longer than the lateral support portion 140.

That is, the lateral support portion 140 induces a correct posture of the pelvis, and allows the movement of an upper body to some extent. Referring back to FIG. 13, the spinal column support according to still another exemplary embodiment of the present invention includes the main body 100 for supporting the user's spinal column, and the main body 100 includes: the lumbar vertebra support portion which stands up to face the backrest of the chair and supports the user's waist; and the gluteal region support portion 130 which is placed on the seat of the chair and faces the user's gluteal muscle, and a stimulation crest 125 protrudes in the longitudinal direction in an elongated manner on the lumbar vertebra support portion 120 in order to stimulate the user's back muscle.

The lumbar vertebra support portion 120 stimulates the user's lumbar vertebra 50 and the peripheral muscles. The gluteal region support portion 130 is disposed at a portion that faces the user's gluteal region. The stimulation crest 125 is formed in an elongated manner in the longitudinal direction, and stimulates the spinal erector muscle 95 and the quadratus lumborum muscle 97 among the peripheral muscles of the lumbar vertebra 50. Therefore, with the relaxation of the spinal erector muscle 95 and the quadratus lumborum muscle 97, the user may maintain correct postures of the lumbar vertebra 50 and the pelvis.

FIG. 17 is a perspective view of the spinal column support according to yet another exemplary embodiment of the present invention.

Referring to FIGS. 12 and 17, the spinal column support according to yet another exemplary embodiment of the present invention includes a support protrusion 111 which is formed in the sacrum accommodating groove 110 and stimulates a portion between an upper side of a sacra apex and a sacral base which corresponds to a triangular portion of the user's coccyx.

The spinal column support according to yet another exemplary embodiment of the present invention includes the main body 100 for supporting the user's spinal column, and the main body 100 includes support protrusions 111 which protrude at a position that faces the portion between the upper side of the sacra apex and the sacral base which corresponds to the triangular portion of the user's coccyx.

The sacral vertebrae include the first sacral vertebra, the second sacral vertebra, the third sacral vertebra, the fourth sacral vertebra, and the fifth sacral vertebra. The first sacral vertebra is a protruding bone that protrudes at a lower side of the fifth lumbar vertebra. The first sacral vertebra is a protruding bone formed at a lower side of the first sacrum. The first sacral vertebra and the second sacral vertebra are referred to as a sacrum upper part, and the third sacral vertebra, the fourth sacral vertebra, and the fifth sacral vertebra are referred to as a sacrum lower part.

The support protrusion 111 stimulates still point inducing points 81 of the sacrum 40. During the flexion phase, the first sacral vertebra and the second sacral vertebra rotate toward the backrest of the chair. However, the support protrusion 111 supports the first sacral vertebra and the second sacral vertebra, and inhibits the rotations of the first sacral vertebra and the second sacral vertebra, thereby interrupting the flexion phase. Therefore, the support protrusion 111 induces the user's still point.

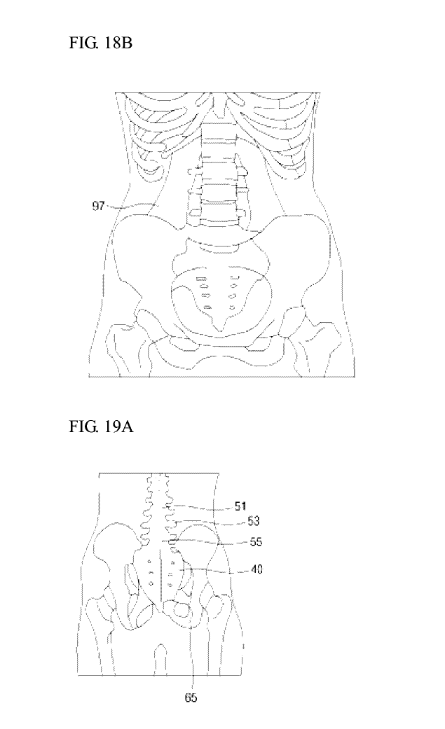

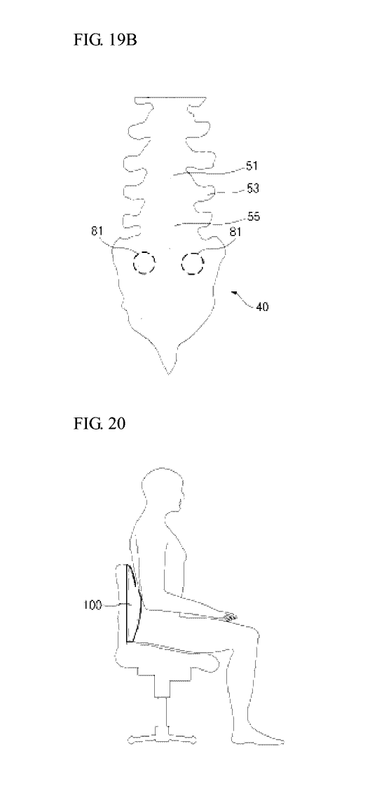

FIG. 18A is a view illustrating spinal erector muscles, and FIG. 18B is a view illustrating quadratus lumborum muscles. FIGS. 19A and 19B are views illustrating body points subjected to stimulation by the respective configurations illustrated in FIGS. 12 and 17. FIG. 20 is a view illustrating a state in which the spinal column support according to still another exemplary embodiment of the present invention is used.

Referring to FIGS. 18 to 20, the gluteal region accommodating groove 131 according to yet another exemplary embodiment of the present invention is formed at a portion that corresponds to an ischium 65. The sacrum accommodating groove 110 is formed at a position where the sacrum 40 is accommodated. The support protrusion 111 is formed at a portion that corresponds to the still point inducing point 81 of the sacrum 40, and stimulates a part of the sacrum 40. The inner trough 123, among the troughs 121, is formed at a portion that faces the lumbar vertebral spinous process 51, and accommodates the lumbar vertebral spinous process 51.

The inner stimulation crest 127, among the stimulation crests 125, is formed at a portion that faces the lumbar vertebra transverse process. The inner stimulation crest 127 is formed at a portion that faces the spinal erector muscle 95, and stimulates the spinal erector muscle 95. The outer trough 124 is formed at a lateral side of the inner stimulation crest 127. With the outer trough 124, the outer stimulation crest 128 may protrude and stimulate the quadratus lumborum muscle 97.

While the exemplary embodiments of the present invention have been illustrated and described above, the present invention is not limited to the aforementioned specific exemplary embodiments, various modifications may be made by a person with ordinary skill in the technical field to which the present invention pertains without departing from the subject matters of the present invention that are claimed in the claims, and these modifications should not be appreciated individually from the technical spirit or prospect of the present invention.

1. A spinal column support comprising:
a main body for supporting a user's spinal column,
wherein the main body includes:
a sacrum accommodating groove which is concavely formed to accommodate the user's sacrum; and
a lumbar vertebra support portion which supports a lumbar vertebra connected with the user's sacrum.

2. The spinal column support of claim 1, wherein the main body further includes a support protrusion which protrudes to support a part of the user's sacrum when the user's sacrum is positioned in the sacrum accommodating groove.

3. The spinal column support of claim 2, wherein the support protrusion is formed at a position that corresponds to at least one of the user's first sacrum and second sacrum.

4. The spinal column support of claim 2, wherein the support protrusion is formed at a position that corresponds to the user's sacrum upper part, and the sacrum accommodating groove accommodates the user's sacrum lower part.

5. The spinal column support of claim 2, wherein the support protrusion is formed to be spaced apart from the user's fifth lumbar vertebra so as not to support a load of the user's fifth lumbar vertebra.

6. The spinal column support of claim 2, wherein the support protrusion is formed between the user's long bones and formed within a size range in which the support protrusion does not support the user's long bones.

7. The spinal column support of claim 2, wherein the lumbar vertebra support portion has a plurality of inner stimulation crests which protrude in an elongated manner to support the user's spinal erector muscle, wherein
an inner trough is formed between the plurality of inner stimulation crests to accommodate the user's lumbar vertebra spinous process, and the inner trough extends toward a center of the support protrusion and meets the support protrusion, wherein
the inner stimulation crest extends from the support protrusion, and is formed in parallel with the user's spinal column, wherein
the lumbar vertebra support portion includes a plurality of outer stimulation crests which protrudes in an elongated manner to support the user's quadratus lumborum muscle, and the inner stimulation crest is formed between the plurality of outer stimulation crests.

8-10. (canceled)

11. The spinal column support of claim 7, wherein the lumbar vertebra support portion includes outer troughs formed between the inner stimulation crests and the outer stimulation crests so that pressure is concentrated on the user's spinal erector muscle, the outer troughs extend into the sacrum accommodating groove, and the support protrusion is formed between the outer troughs.

12. The spinal column support of claim 7, wherein the outer stimulation crests extend in a direction toward the sacrum accommodating groove and define an edge of the sacrum accommodating groove.

13. The spinal column support of claim 1, wherein the sacrum accommodating groove is formed at a position where the user's medial sacral crest is accommodated.

14. The spinal column support of claim 13, wherein the main body includes:
a lumbar vertebra support portion which stands up to face a backrest of a chair and supports the user's waist; and
a gluteal region support portion which is placed on a seat of the chair and faces the user's gluteal muscle, and
the sacrum accommodating groove is formed between the gluteal region support portion and the lumbar vertebra support portion, wherein
the gluteal region support portion has gluteal region accommodating grooves which is recessed to accommodate the user's protruding gluteal muscle, and the gluteal region accommodating grooves are divided into left and right grooves by a separation crest which protrudes at a portion that faces the user's coccygeal vertebra, wherein
the sacrum accommodating groove is formed on an extending line in a direction from the separation crest to the lumbar vertebra support portion.

15-16. (canceled)

17. The spinal column support of claim 14, wherein the lumbar vertebra support portion has an inner trough which is recessed to accommodate the user's lumbar vertebral spinous process (lumbar spinosis).

18. The spinal column support of claim 1, wherein the sacrum accommodating groove is formed at a position where the user's medial sacral crest is accommodated.

19. The spinal column support of claim 18, wherein the main body includes:
a lumbar vertebra support portion which stands up to face a backrest of a chair and supports the user's waist; and
a gluteal region support portion which is placed on a seat of the chair and faces the user's gluteal muscle, and
the sacrum accommodating groove is formed between the gluteal region support portion and the lumbar vertebra support portion.

20. The spinal column support of claim 19, wherein the gluteal region support portion has gluteal region accommodating grooves which are recessed to accommodate the user's protruding gluteal muscle, the gluteal region accommodating grooves are divided into left and right grooves by a separation crest which protrudes at a portion that faces the user's coccygeal vertebra, and the sacrum accommodating groove is formed on an extending line in a direction from the separation crest to the lumbar vertebra support portion.

21. The spinal column support of claim 20, wherein the lumbar vertebra support portion has an inner trough which is recessed to accommodate the user's lumbar vertebral spinous process (lumbar spinosis), the inner trough extends in a longitudinal direction, and one side of the inner trough is connected with the sacrum accommodating groove.

22. The spinal column support of claim 21, wherein the lumbar vertebra support portion has inner stimulation crests which protrude at left and right sides of the inner trough and stimulate the user's spinal column transverse process and spinal erector muscle, and based on the inner stimulation crest, the inner trough is formed at one side, and outer troughs are formed at the opposite sides in an elongated manner, wherein
based on the outer trough, the lumbar vertebra support portion has the inner stimulation crests which are formed at one side, and outer stimulation crests which are formed at the opposite sides and stimulate the user's quadratus lumborum muscle, wherein
the lumbar vertebra support portion has lateral support portions which vertically protrude in an elongated manner at left and right ends of the lumbar vertebra support portion and fix the user's waist, the lateral support portion extends up to a portion that does not come into contact with the user's rib, and the inner stimulation crest and the outer stimulation crest are formed to be longer than the lateral support portion.

23-24. (canceled)

25. The spinal column support of claim 1, wherein support protrusions, which protrude at a position that faces a portion between an upper side of a sacra apex and a sacral base which corresponds to a triangular portion of the user's coccyx, are formed in the sacrum accommodating groove.

26. A spinal column support comprising:
a main body for supporting a user's spinal column,
wherein the main body includes:
a sacrum accommodating groove which is concavely formed to accommodate the user's sacrum;
a support protrusion which is formed at an end portion of the sacrum accommodating groove and interrupts the movement of the sacrum so as to interrupt the movement of a flexion phase of a sacrum caused by a flow of a cerebrospinal fluid; and
a lumbar vertebra support portion which extends in a direction from the support protrusion to a user's spinal column and supports the user's spinal column.

27. (canceled)

28. A spinal column support comprising:
a main body for supporting a user's spinal column,
wherein the main body includes support protrusions which protrude at a position that faces a portion between an upper side of a sacra apex and a sacral base which corresponds to a triangular portion of the user's coccyx.

29. (canceled)
